(19) United States
(12) Patent Application Publication
(10) Pub. No.: US 2010/0178628 A1
(43) Pub. Date: Jul. 15, 2010

(54) ORTHODONTIC DEVICE AND ORTHODONTIC METHOD

(76) Inventor: Ok Kyoung Kim, Seoul (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 12/440,056

(22) PCT Filed: Sep. 7, 2007
(86) PCT No.: PCT/KR07/04335

§ 371 Date: Mar. 5, 2009

(30) Foreign Application Priority Data
Sep. 8, 2006 (KR) 10-2006-0087047
Nov. 2, 2006 (KR) 10-2006-0107935

(51) Int. Cl. A61C 7/00; A61C 7/14; A61C 7/28

(52) U.S. Cl. 433/10; 433/18; 433/8; 433/21; 433/24

(57) ABSTRACT

An orthodontic device and an orthodontic method that can prevent an orthodontic treatment from being eccentrically performed while aligning straightly tooth. The orthodontic device includes teeth-attachment unit attached to an orthodontic tooth object; and hook member provided in the teeth-attachment unit and having a connection part of traction unit for orthodontic treatment that is located in the vicinity of a center of resistance (CR) of a tooth. In addition, the orthodontic device includes teeth-attachment unit; and hook member provided in the teeth-attachment unit and having a connection part of traction unit for orthodontic treatment that is located in the vicinity of at least gingiva. Since the teeth-attachment unit of a bracket or a button is substantially horizontal to a traction line of the traction unit, it is possible to perform the orthodontic treatment effectively without eccentric phenomenon in which the tooth and a dental root are tilted.

### TECHNICAL FIELD

The present invention relates to an orthodontic device and an orthodontic method capable of straightly aligning teeth, and more particularly, to an orthodontic device and an orthodontic method in which a connection part (connection point) between hook member provided at teeth-attachment unit of a bracket or a button (for orthodontic treatment-straitening irregular teeth) attached to a tooth and traction unit providing orthodontic force is located in the vicinity of a center of resistance of the tooth or in the vicinity of at least a gingiva, thereby performing the orthodontic treatment effectively without eccentric phenomenon in which the tooth is tilted during orthodontic treatment.

### BACKGROUND ART

Irregularly arranged teeth, malocclusion (the state where occlusion is not matched), or facial protrusion results from teeth and stomatognathic face do not have grown up in a proper place due to growth abnormality of the teeth, growth abnormality of a jaw bone, bad habit such as finger sucking, during infant, bad dietary habit, and/or inheritance.

The irregular arrangement of the teeth, the malocclusion, or the facial protrusion may result in passive interpersonal-relations and also reduces a uniform pulverization of foods that is a basic function of the teeth.

Accordingly, in order to solve these problems, it is becoming more common that the orthodontic treatment reorganizes an alveolar bone surrounding the teeth by teeth movement applying a constant force to the teeth.

For example, FIG. 1 illustrates an example of a conventional orthodontic device 200 known as a bracket. In this case, the bracket is a labial bracket which is exposed to the outside of teeth.

On the contrary, the bracket which is not exposed to the outside of the teeth is referred to as a lingual bracket (see FIG. 13).

Of these labial and lingual brackets, in case of the children whose oral care is difficult, or the extremely asymmetric teeth, the labial bracket is used for straightening irregular teeth in terms of efficiency rather than aesthetic appreciation.

Meanwhile, a metal-bracket is mainly used in early years, but brackets of transparent materials, such as a ceramic or resin are used in recent years so as to provide aesthetic effect.

Furthermore, a conventional orthodontic device 200 shown in FIG. 1, that is, a bracket is provided with a body 210, a slot 212, an orthodontic wire 220, a binder member 230, and tie wings 240. The bracket body 210 is attached to the tooth T, and the orthodontic wire 220 is inserted into the slot 212 linked between the teeth and clamping the inserted orthodontic wire 220. Furthermore, the binder member 230 is an engagement band for clutching the orthodontic wire 220 to the bracket body 210, and the tie wings 240 is engaged with the binder member 230.

As shown in FIG. 1, the slot 212 is formed by a recessed shape between the tie wing 240 on the bracket body 210, and a teeth-attachment surface of the bracket body 210 is curved so as to be adapted to an outward appearance.

Next, as shown in FIG. 2, according to treatment using the orthodontic device 200 of the conventional bracket, the bracket body 210 is attached to an orthodontic tooth object, for example, a canine tooth attached by an adhesive agent and so on.

After inserting the orthodontic wire 220 into the bracket slot (212 in FIG. 1), the inserted orthodontic wire 220 is engaged by the binder member 230, for example, a band or a steel wire to combine a pair of tie wings 240. For this reason, the orthodontic wire 220 is fixed to the bracket body 210.

Even though not shown in separate drawings, the orthodontic wire 220 inserted into the body may be fixed by a cover member instead of the tie wings. The cover member is integrally formed on the slot to cover and fix the orthodontic wire 220.

Next, as shown in FIG. 2, traction unit 270 is connected to a projection 250 protruded from the tie wing of the bracket. The traction unit 270 is connected to anchor member 260 as a mini-implant (screw) or plate implanted in a jaw bone or an alveolar bone. With this configuration, the traction unit 270 pulls the tooth to conduct the orthodontics.

In this case, like FIG. 2, the traction unit may include at least one selected from the group consisting of a traction wire, a spring, and an elastic chain, or a combination thereof (see FIGS. 6 and 7). In FIG. 2, a mark T′ denotes ‘a dental root’ part, and a mark G denotes ‘a gingiva part’.

However, as shown in FIG. 3, the conventional orthodontic device 200 has following problems.

For example, one end of the traction unit 270 is connected to the anchor member 260 implanted in the jaw bone or the alveolar bone, and the other end thereof is connected to a lower projection 250 of the bracket 210 at an angle (θ1 degree based on the horizon of the anchor member).

In this case, since a connection angle of the traction unit connected to the bracket tilts based on the anchor member, a pulling force F1 is applied to the tooth T during orthodontics.

For this reason, the tooth T is not horizontally pulled together with the dental root T′, and the tooth T is pulled in the slope direction by θ2 degree. Accordingly, an eccentric phenomenon is generated.

In the conventional orthodontic device 200, when the orthodontic treatment is operated by connecting the traction unit 270 with the orthodontic device 200 of the bracket, the tooth is eccentrically pulled. Accordingly, a normal orthodontic treatment is hard, and an orthodontic period is long.

### DISCLOSURE OF INVENTION

### Technical Problem

An aspect of the present invention provides an orthodontic device and an orthodontic method in which a connection part (connection point) between traction unit providing orthodontic force during orthodontic treatment and hook member provided at teeth-attachment unit is located in the vicinity of a gingiva to correspond to a center of resistance of the tooth or dental root. The orthodontic device and the orthodontic method according to the invention can improve orthodontic properties by pulling out a tooth and a dental root in a horizontal state without eccentric phenomenon.

### Technical Solution

According to an aspect of the present invention, there is provided an orthodontic device comprising: teeth-attachment unit attached to an orthodontic tooth object; and hook member provided in the teeth-attachment unit and having a connection part of a traction unit for straitening irregular teeth that is located in the vicinity of a center of resistance (C.R) of the tooth.

According to another aspect of the present invention, there is provided an orthodontic device comprising: teeth-attachment unit attached to an orthodontic tooth object; and hook member provided in the teeth-attachment unit and having a connection part of a traction unit for straitening irregular teeth that is located in the vicinity of at least gingiva.

According to still another aspect of the present invention, there is provided an orthodontic device comprising: teeth-attachment unit attached to an orthodontic tooth object; and hook member provided in the teeth-attachment unit and having a connection part of a traction unit for straitening irregular teeth that is located in the vicinity of at least gingiva from a center of resistance (C.R) of the tooth.

According to further still another aspect of the present invention, there is provided an orthodontic method comprising; locating a connection part between a hook member and a traction unit in the vicinity of a center of resistance (C.R) of a tooth or in the vicinity of at least gingiva so as to prevent an orthodontic tooth object from being eccentrically pulled out, the hook member being provided in a bracket or a button of an orthodontic device, the traction unit being connected to anchor member to pull out the tooth, and the bracket or the button of the orthodontic device being attached to the tooth, alone or in combination thereof.

### Advantageous Effects

According to an orthodontic device and an orthodontic method of the invention, since a connection part of traction unit connected between anchor member and a bracket or a button of teeth-attachment unit is located in the vicinity of a gingiva corresponding to a center of resistance of a tooth in consideration of the total length of the tooth and a dental root, an orthodontic treatment is performed by pulling out the teeth and the dental root in a horizontal state with respect to the anchor member without eccentric phenomenon, thereby improving orthodontic properties.

In addition, since the connection part of the traction unit and the hook member extended from the orthodontic device of the bracket or the button is located in the vicinity of the gingiva, the orthodontic treatment is easily performed, and the exterior exposure of the connection line between the anchor member and the traction unit can be reduced. Therefore, according to the orthodontic device and the orthodontic method of the invention, the appearance after the orthodontic treatment is aesthetically beautiful.

### BRIEF DESCRIPTION OF THE DRAWINGS

FIG. 1 is a perspective view illustrating one example of a known orthodontic device.

FIG. 2 is a schematic view illustrating an orthodontic treatment state of the orthodontic device of FIG. 1.

FIG. 3 is a schematic view for explaining problems to be generated during treatment of the orthodontic device of FIG. 1.

FIG. 4 is a perspective view illustrating a bracket-shaped orthodontic device according to the invention, hook member being formed at a tie wing of the bracket.

FIG. 5 is a perspective view illustrating a bracket-shaped orthodontic device according to the invention, hook member being formed at a body of the bracket.

FIGS. 6 and 7 are perspective views illustrating the treatment state of the orthodontic device according to the invention based on different traction unit.

FIG. 8 is a state diagram illustrating orthodontic treatment state based on the orthodontic device according to the invention.

FIG. 9 is a perspective view illustrating a modification example of hook member according to the invention.

FIGS. 10A to 10C are schematic views illustrating another modification example of the hook member according to the invention.

FIG. 11 is a block diagram illustrating further another modification example of the hook member according to the invention.

FIGS. 12A and 12B are side views illustrating further another modification example of the hook member according to the invention.

FIGS. 13A and 13B are a front view and an installed state diagram illustrating a lingual bracket-shaped orthodontic device according to the invention, respectively.

FIG. 14 is a perspective view illustrating the orthodontic treatment state of a button-shaped orthodontic device according to the invention;

FIGS. 15A and 15B are a perspective view and a side view illustrating the orthodontic device of FIG. 14, respectively.

FIGS. 16A and 16B are a perspective view and a side view illustrating a modification example of the orthodontic device of FIG. 15, respectively;

FIGS. 17A to 17C are schematic views illustrating modification examples of the hook member in the orthodontic device of FIG. 14.

FIG. 18 is a block diagram illustrating another modification example of the hook member in the orthodontic device of FIG. 14;

FIGS. 19A and 19B are front views illustrating further another modification example of the hook member in the orthodontic device of FIG. 14.

FIG. 20 is a perspective view illustrating a combinational application of the bracket (in the prior art) and the button including the hook member according to the invention; and

FIGS. 21 and 22 are perspective views illustrating a rod-shaped (steel wire) hook member provided in the bracket and the button in the orthodontic device according to the invention.

### BEST MODE FOR CARRYING OUT THE INVENTION

Hereinafter, exemplary embodiments of the invention will be described in detail with reference to the accompanying drawings.

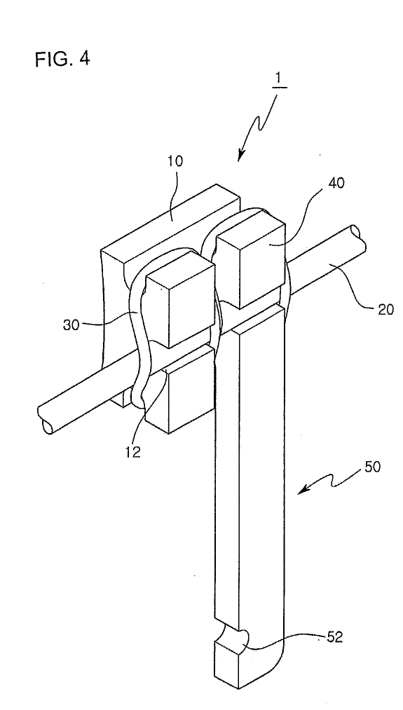

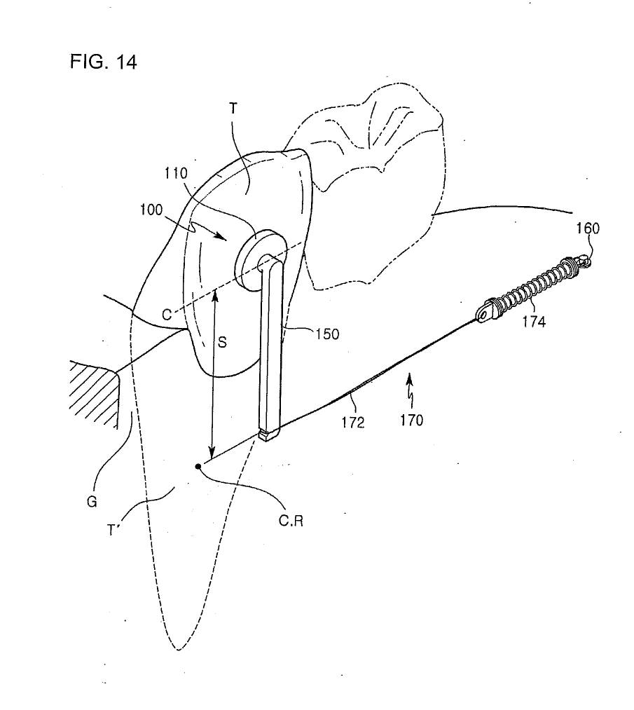

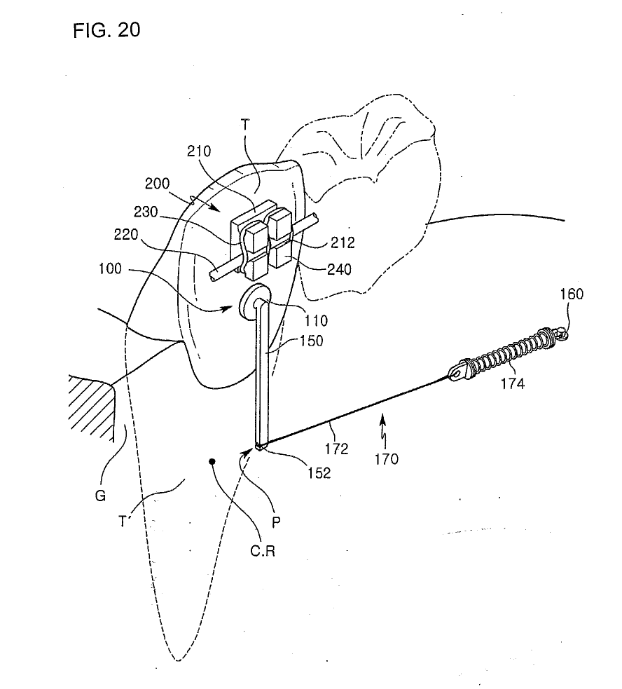

FIGS. 4 to 13 illustrate a bracket as an example of teeth-attachment unit in an orthodontic device 1 of the present invention, FIGS. 14 to 19 show a button as another example of the teeth-attachment unit in an orthodontic device 100, and FIG. 20 illustrates a combinational application of the bracket and the button.

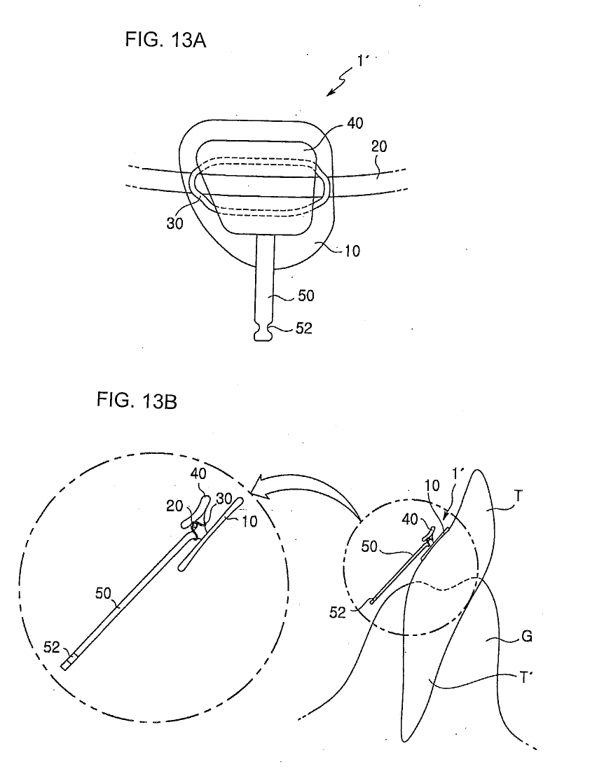

As described above, FIGS. 4 to 12 illustrate the labial bracket-shaped orthodontic device 1 which has good orthodontic properties or convenient treatment, even though the labial bracket is exposed. FIG. 13 illustrates a lingual bracket-shaped orthodontic device 1′ which takes aesthetic properties into consideration.

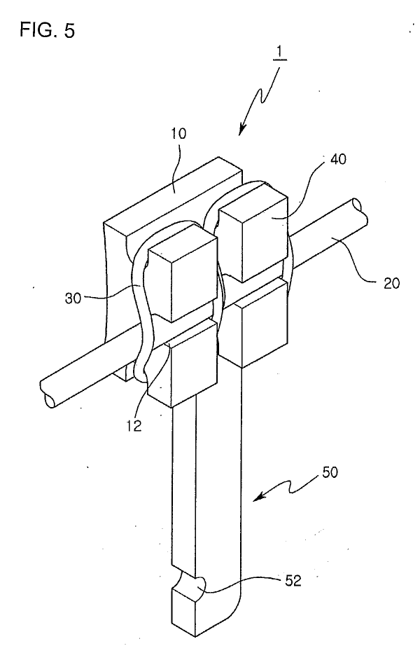

First, FIG. 4 illustrates the orthodontic device 1 of the invention in which hook member 50 is formed at a tie wing 40 provided on a bracket body 10, and FIG. 5 illustrates the orthodontic device 1 of the invention in which the hook member 50 is integrally formed at the bracket body 10.

However, hereinafter the bracket-shaped orthodontic device 1 in which the hook member 50 is integrally formed at the tie wing 40 of FIG. 4 will be described.

In the figure, four tie wings 40 are provided at the bracket body 10, but the invention is not limited thereto. Two tie wings of large size may be formed at upper and lower sides of the bracket body 10.

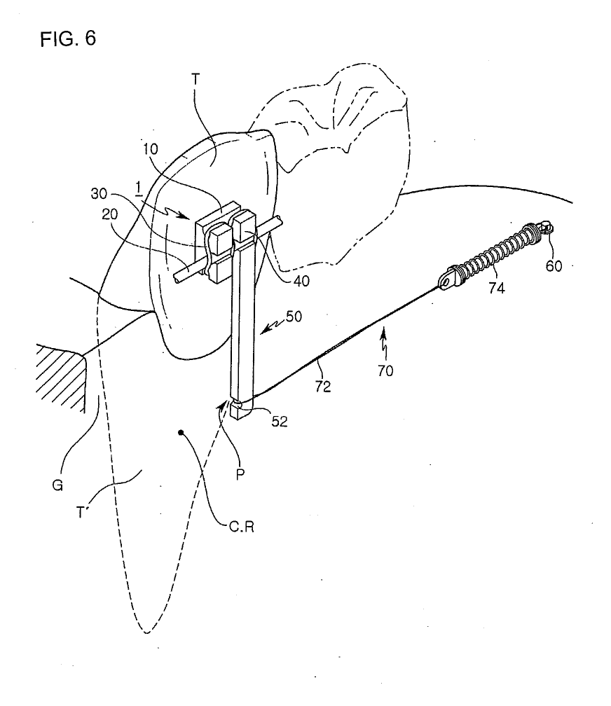

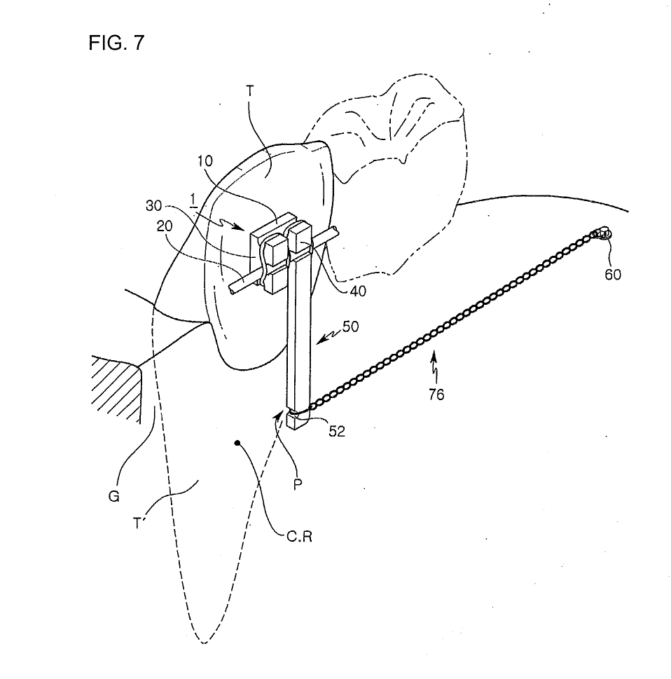

As shown in FIGS. 6 and 7, the orthodontic device 1 of the invention is integrally provided to one of the bracket of the teeth-attachment unit attached to the tooth T of an orthodontic object and the tie wings 40 of the bracket. In addition, the orthodontic device 1 includes the hook member 50 having a connection part (connection point P) of traction unit 70. The connection point P is located in the vicinity of a center of resistance (C.R) of the tooth T.

Alternatively, out of accordance with the center of resistance of the orthodontic tooth object T, the connection part (connection point P) of the traction unit 70 and the hook member 50 may be located in the vicinity of at least gingiva G, which is a center portion of the total length of the orthodontic tooth object T and a dental root T′.

In this case, as shown in FIGS. 6 and 7, since the vicinity of the center of resistance (C.R) of the tooth T becomes the vicinity of the gingiva in consideration of the total length of the tooth T and the dental root T′, it is the most preferable that the connection part (connection point P) of the traction unit 70 and the hook member 50 is located in the vicinity of the gingiva to correspond to the center of resistance (C.R) of the tooth.

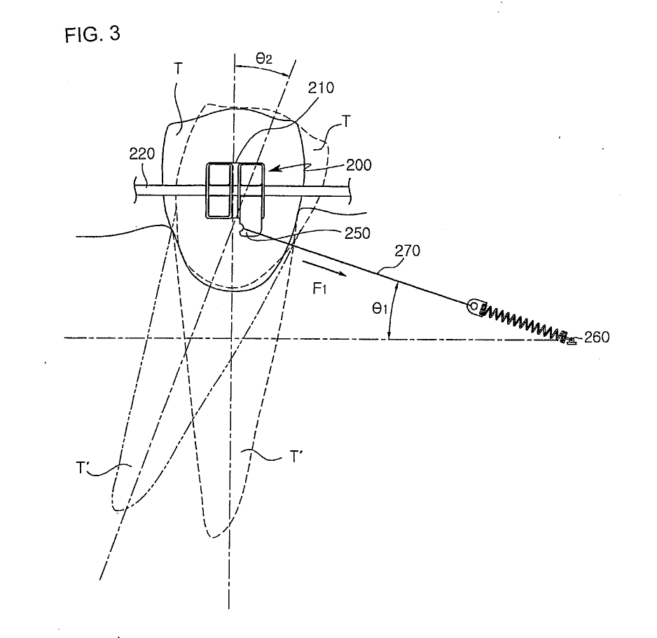

Accordingly, the orthodontic device 1 of the invention connects the hook member 50 to the traction unit 70 in a way different from the known orthodontic device 200 of FIG. 3. That is, the hook member 50 is extended to the vicinity of the gingiva so as to correspond to the center of resistance of the tooth, and the lower end of the hook member 50 is connected to the traction unit 70. Accordingly, the tooth T and the dental root T′ are pulled out in approximately horizontal state with a traction line without eccentric phenomenon (see FIG. 3).

Meanwhile, the bracket and the hook member of the orthodontic device 1 may be integrally formed by a metal, ceramic, or resin (plastic).

The orthodontic device 1 performs the orthodontic treatment by connecting the traction unit 70 to anchor member 60 of a mini screw or an implant shape, a plate shape and so on. The orthodontic device 1 is mainly applied to an independent tooth T such as a canine tooth, but the invention is not necessarily limited thereto.

Furthermore, as shown in FIGS. 4 and 5, the bracket body 10 of the bracket-shaped orthodontic device 1 includes fundamentally a slot 12 into which an orthodontic wire 30 is inserted.

In addition, the bracket body 10 includes at least one of the tie wings 40 for engaging a binder member 30. The binder member 30 is used to fasten an orthodontic wire 20 inserted into the slot 12 to the bracket body 10.

Furthermore, the slot 12 actually corresponds to a space between the tie wings 40. The slot 12 is formed so as to correspond to the diameter of the orthodontic wire 20.

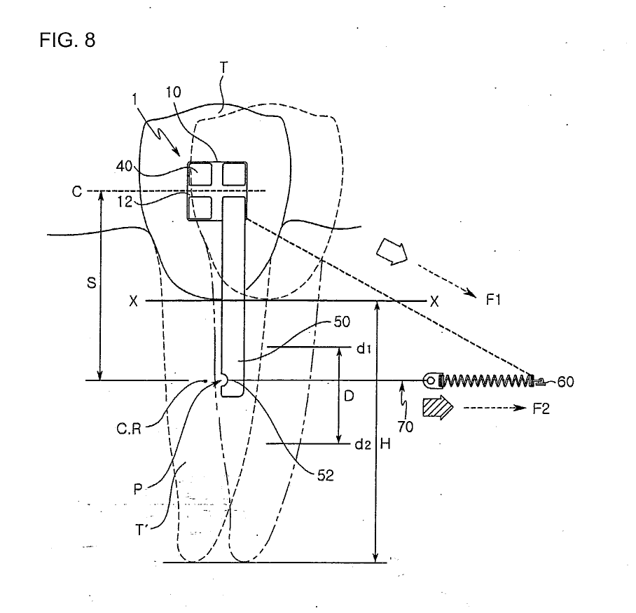

In this case, the slot 12 is generally formed along a center line (C of FIG. 8) of the bracket of the teeth-attachment unit, in actual fact. As described in the prior art, the orthodontic device 1 of the bracket having the tie wings 40 is only one example. Therefore, it is possible to use the orthodontic device not including the tie wings.

For example, even though not shown in separate drawings, the bracket of another shape can be used. That is, the bracket body 10 is provided with an integrally formed cover member (lid) instead of the tie wings, and the cover member covers the slot 12 on the bracket body. After the orthodontic wire 20 is inserted into the slot, the bracket is engaged with the binder member 30 to fix the orthodontic wire 20.

Accordingly, in case of the bracket including the cover member, the hook member 50 is integrally provided (extended) at the end of the cover member.

However, hereinafter this embodiment of the invention will be described based on the orthodontic device 1 of the bracket including the tie wings.

Next, FIGS. 6 and 7 illustrate the treatment state of the bracket-shaped orthodontic device 1. FIGS. 6 and 7 are different from each other only in the shape of the traction unit.

For example, FIG. 6 illustrates the traction unit 70 configured by combining a traction wire 72 and a spring 74, and FIG. 7 illustrates the traction unit of an elastic chain 76.

The traction unit of FIGS. 6 and 7 are exemplary ones, but the invention is not limited thereto. In this case, the traction wire 72 may include a steel wire or a rubber having an elastic force.

In addition, as shown in FIGS. 6 and 7, the orthodontic wire 20 is inserted into the slot 12 of the bracket body 10 during orthodontic treatment and is then fixed to the bracket body 10 by engaging an engagement band of the binder member 30 with the tie wings 40.

Accordingly, since the orthodontic wire is liked to the bracket of the teeth-attachment unit attached to each tooth, it is possible to perform an orthodontic treatment of total dentitions.

In this case, according to the orthodontic device 1 of the invention, as shown in FIGS. 4 and 5, the hook member 50 may be provided by a bar shape extended from either of the bracket body 10 itself or the tie wings 40 provided on the bracket body 10, the bar-shaped hook member 50 is extended by a predetermined length.

Next, the position of the connection part of the hook member 50 and the traction unit 70, that is, the position of the connection point P of the hook member and the traction unit will be described in detail with reference to FIG. 8.

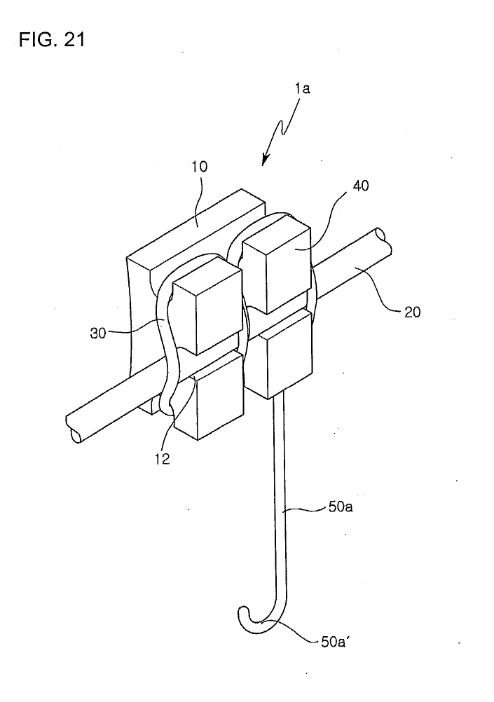

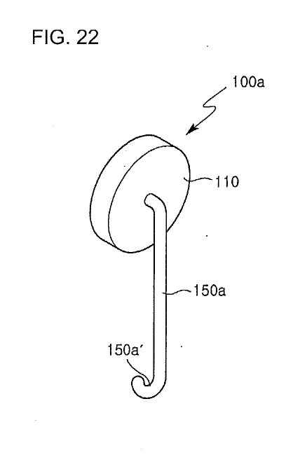

That is, as shown in FIG. 8, the hook member 50 (hook member of the bar shape or a rod shape as shown in FIGS. 21 and 22) in the orthodontic device 1 is extended to the vicinity of the center of resistance (C.R) of the tooth, that is, the center at which the tooth and the dental root are pulled together on the whole during orthodontic treatment so as to correspond to the center. It is preferable that the traction unit 70 is connected to the lower end of the hook member 50 at the extended state.

In the art, the center of resistance (C.R) of the tooth has been researched.

For example, a research for the center of resistance of the tooth was published in orthodontic-related journals, for example, 1988, AJO (American Journal of Orthodontics), Tanne (p 337-345), 2002, AJO Schneider (p257-265). When integrating these journals, the center of resistance (C.R) of the tooth is in the range D of 24% (d1 of FIG. 8)) to 45% (d2 of FIG. 8) of the total length H of the dental root T′ based on the upper end (X-X of FIG. 8) of the dental root T′.

Accordingly, assuming that the total length of the dental root T′ is H in FIG. 8, the center of resistance (C.R) of the tooth is in the range of 0.24 to 0.45×H from the upper end (X-X) of the dental root.

The reason why the center of resistance (C.R) of the tooth has the above-described range is because the shape of the dental root T′ differs in every person and because the extent supported to an alveolar bone is different to each other.

That is, assuming that the connection part (connection point P) of the hook member 50 and the traction unit 70 in the orthodontic device 1 is in the above-described range, the force pulled by the traction unit becomes F2 shown in FIG. 8. The tooth T and the dental root T′ are pulled out in approximately horizontal state by the force F2.

For example, when the tooth T is a canine tooth, the length ‘H’ of the dental root is generally in a range of 13 to 19 mm, and is averagely 16 mm. Accordingly, in this case, the center of resistance (C.R) of the tooth becomes in the range D′ of (16×0.24=) 3.84 mm (d1) to (16×0.45=) 7.2 mm (d2) from the upper end (X-X of FIG. 8) of the dental root.

Therefore, it is preferable that the connection point P of the hook member 50 and the traction unit 70 is located in the range (D′ of FIG. 8) of 3.84 mm to 7.2 mm, when the length of the dental root is at least 16 mm.

However, the above-described range is about an average length of the dental root. Accordingly, allowing for the fact that the length of the dental root is in a range of 13 to 19 mm, the range of the center of resistance of the tooth becomes 3.12 to 8.55 mm.

In this case, if the connection part of the hook member 50 and the traction unit 70, that is, connection point P deviates from the range of 0.24 to 0.45×H, there may be a problem that the tooth and the dental root are pulled at an angle in the traction direction or in a direction opposite thereto.

Meanwhile, regardless of the fact that the connection part of the hook member 50 and the traction unit 70 is the center of resistance (C.R) of the tooth in the orthodontic device 1 of the FIG. 8, only allowing for the total length of the tooth and the dental root, the length S of the hook member 50 is extended by about 7 to 14 mm. In this case, it is also preferable that the connection part (connection point P) of the hook member 50 and the traction unit 70 is located in the vicinity of the gingiva G.

However, preferably, the length S of the hook member 50 is from the center line C (corresponding to the center line of the slot 12) of the bracket body 10 to the connection point P of the traction unit. Substantially, the connection point of the traction unit may be the lower end of the hook member.

In this case, in FIG. 8, when the extension length S of the bar-shaped hook member 50 is less than 7 mm or longer than 14 mm, the bar-shaped hook member 50 becomes very short or long. In this case, the tooth is eccentrically pulled out in the traction direction or a direction opposite thereto.

In addition, when the length of the hook member is very long, that is, when the length of the hook member is larger than 14 mm, the gingival or oral mucosa is damaged by the hook member. In this case, the orthodontic device including the hook member is inconvenient in use. Accordingly, most preferably, the length of the hook member is 8 to 10 mm.

As described above, in case of the canine tooth, the center of resistance (C.R) of the tooth is in the range of 3.12 mm to 8.55 mm. Furthermore, allowing for the fact that the bracket is generally attached to the center of the tooth, the length from the slot 12 of the bracket body 10 serving as a teeth-attachment unit to the upper end (X-X) of dental root T′ is about 4.5 to 5 mm.

Accordingly, adding the length to the range, the extension length S of the hook member becomes about 7.62 mm (based on 4.5 mm) to 13.55 mm (based on 5 mm).

That is, according to the orthodontic device of the invention, the extension length of the hook member 50 may relate to the range of the center of resistance in the connection point P of the traction unit.

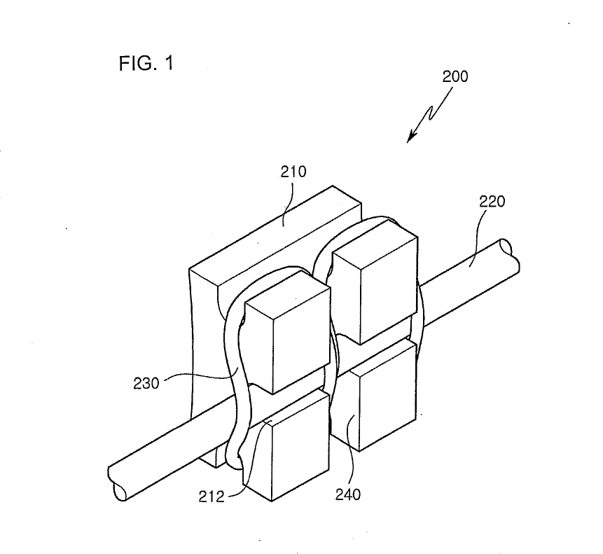

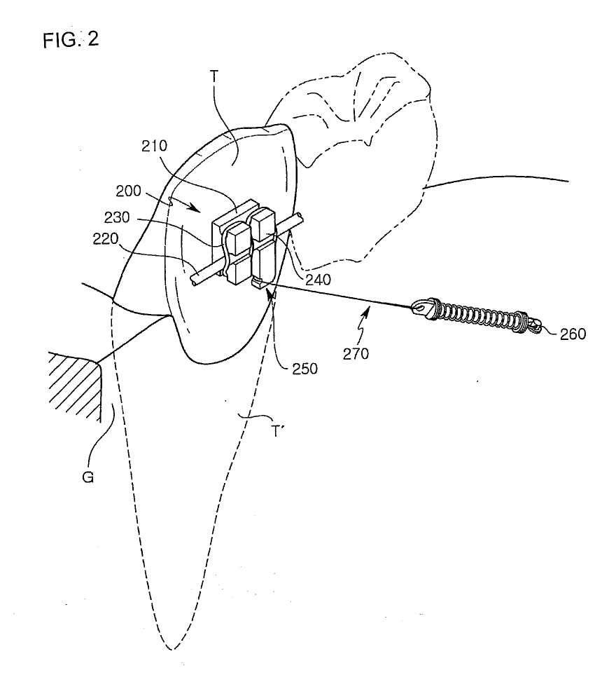

Meanwhile, as shown in FIG. 20, when conducting the orthodontic treatment by using the existing bracket 200 (see the bracket of FIG. 1) and the button-shaped orthodontic device 100, the connection point P of hook member 150 and traction unit 170 is located according to the center of resistance (C.R) of the tooth as shown in FIG. 8, but the extension length of the hook member 150 becomes shorter than that of the hook member 50 of the bracket in FIG. 8.

Therefore, as shown in FIGS. 8 and 20, allowing for the fact that the length of the hook member becomes shorter when using together the bracket 1 or the button 100, it is most preferable that the extension length ‘S’ of the hook member 50 is in the range of about 4 to 14 mm.

In this case, allowing for the fact that the hook member is extended from the center line (see of FIG. 14) of the button, when the extension length of the hook member is shorter than 4 mm, the conventional problems are generated, thereby having no effectiveness. When the extension length of the hook member is longer than 14 mm, it has the problems as described above.

In addition, a spring 74 and a traction wire 72 serving as the traction unit 70 are connected to anchor member 60 and the lower hanger groove 52 of the bar-shaped hook member 50, respectively. Virtually, the hanger groove 52 becomes the connection part (that is, the connection point P) of the traction unit and the hook member.

In this case, not shown in separate drawings, it may be possible to form a hanger hole instead of the hanger groove.

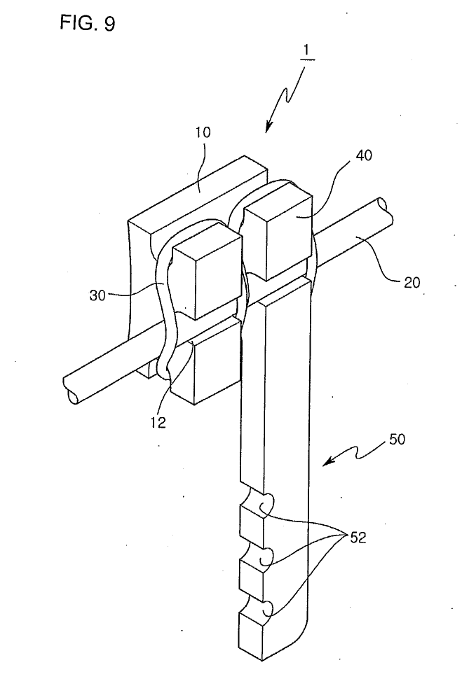

Next, as shown in FIG. 9, a plurality of the hanger grooves 52 (or hanger holes) for connecting the traction unit may be formed at regular intervals from the lower end along of the hook member 50 to be extended.

In this case, since the connection line of the traction unit may be micro-adjusted, it may be possible to cope with the treatment condition of user (person to be treated).

First of all, at least the uppermost groove among the plural hanger grooves 52 of FIG. 9 is located in the vicinity of at least the gingiva G or in the vicinity of the center of resistance of the tooth so as to prevent the tooth from being pulled out eccentrically.

Next, the treatment state by the bracket-shaped orthodontic device 1 of the invention will be described with reference to FIG. 8 in comparison with a conventional one.

For example, in the prior art the traction unit 70 is connected (dotted line) to the bracket body 10 at the intensively inclined state in the anchor member 60. In this case, the traction unit 70 is pulled out in F1 direction, the tooth T is inclined to be eccentric like FIG. 3.

However, like FIG. 8, according to the orthodontic device 1 of the invention, since the connection part (connection point P) of the hook member 50 (that is, the bar-shaped hook member 50 that is integrally extended downwardly from the bracket body or the tie wings) and the traction unit 70 is located in the vicinity of the center of resistance (C.R) of the tooth or in the vicinity of at least the gingiva, the tooth T and dental root T′ are virtually pulled out in a direction of the force F2 by the traction unit 70.

Accordingly, the tooth T and the dental root T′ are pulled out at a substantially horizontal state with respect to the traction line between the traction unit and the anchor member without inclining unlike the prior art.

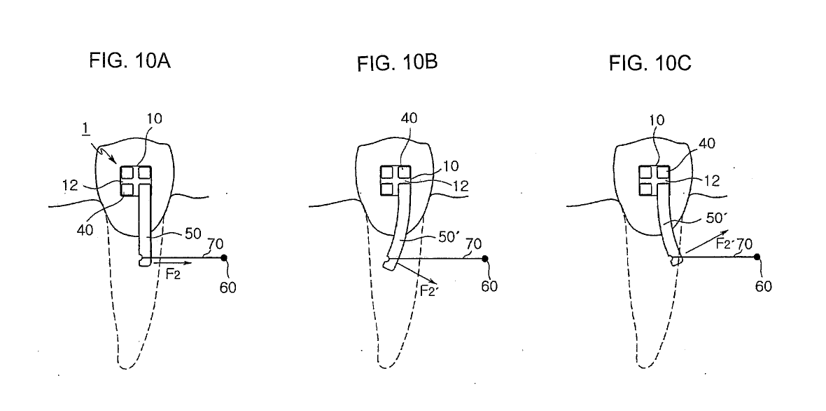

Next, FIGS. 10 to 12 illustrate various examples of the hook member provided at the bracket-shaped orthodontic device 1 according to the invention.

For example, as shown in FIG. 10A, the bar-shaped hook member 50 may be extended in a straight manner from the bracket body or the tie wings. Furthermore, as shown in FIGS. 10B or 10C, hook member 50′ may be extended so as to be curved in a direction opposite to the traction direction pulled out by the traction unit or in the traction direction according to a tooth axis.

In this case, allowing for the tooth axis (orthodontic angle), since the curved hook member 50 may be intentionally adjusted in the traction direction of the force F2 or F2′, the direction of the orthodontic treatment may be easily adjusted at many angles by using one orthodontic device.

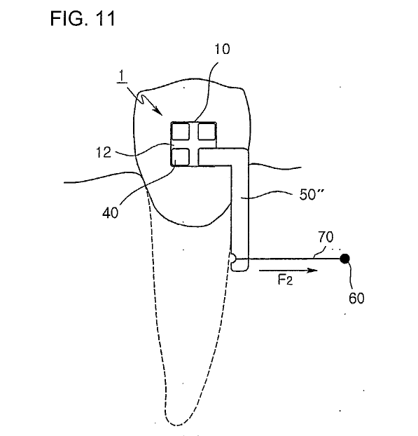

Furthermore, as shown in FIG. 11, the hook member of the invention may be provided with folded hook member 50″ that is extended in the shape of approximately reverse-‘L’ shape folded from the bracket body or the tie wings.

In this case, the connection part (connection point P) of the hook member 50 and the traction unit 70 deviates from the vertical center line of the bracket. Accordingly, in case of using together the bracket and the button like FIG. 20, the interference of the hook member is avoided, thereby conducting easily the overall orthodontic treatment.

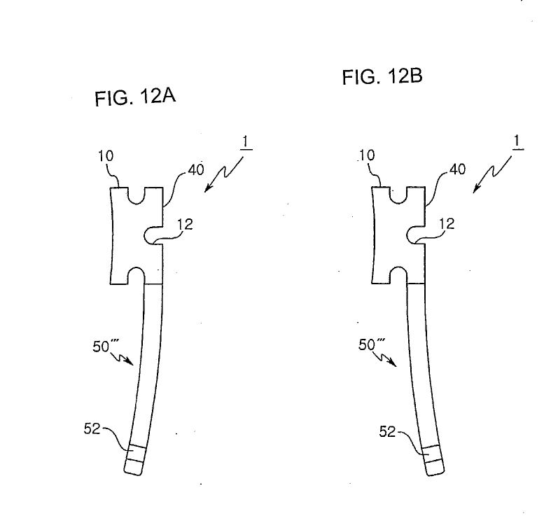

Next, as shown in FIGS. 12A and 12B, according to the orthodontic device 1 of the invention, the hook member may be the shape 50″′ that is extended so as to be curved in a lingual direction (tooth direction) or a buccal direction (opposing direction of the tooth).

In this case, the distance between the lower end of the hook member 50′″ and the gingiva may be adjusted.

Meanwhile, as described above, various shape of the hook member 50, 50′, 50″, and 50′″ provided at the orthodontic device 1 are extended downwardly. However, the hook member is extended upwardly from the bracket or the button when the bracket or button-shaped (that will be described later) orthodontic device is attached to an upper tooth.

Next, FIG. 13 illustrates an orthodontic device 1′ of the lingual bracket.

The shape of this orthodontic device 1′ of the lingual bracket is similar to that of the above-described orthodontic device 1 of the labial bracket. In the orthodontic device 1′ of the lingual bracket, the bracket body 10 is attached to the lingual part of the tooth, the orthodontic wire 20 is passed through the inner side of the tie wing 40 to be engaged by a engagement band of a engagement binder 30, the above-described hook member 50 is provided to be integrally extended from the lower-side tie wing of the tie wings, and the traction unit (see reference numeral 70 of FIG. 5) not shown in FIG. 13 is connected to the hanger groove 52 formed at the lower end of the hook member.

Accordingly, according to the lingual bracket-shaped orthodontic device 1′ of the invention, the connection part (that is, the connection point P) of the hook member and the traction unit, corresponds to the center of resistance of the tooth or is located in the vicinity of the gingiva, thereby improving the orthodontic properties, as well as the labial bracket-shaped orthodontic device 1 of the invention described above.

Accordingly, the above-described orthodontic devices 1 and l′ of the invention are applicable to both of the labial and the lingual brackets.

Next, FIGS. 14 to 19 illustrate another orthodontic device according to the invention, that is, examples including hook member 150 in the button-shaped orthodontic device 100.

However, unlike the bracket-shaped orthodontic devices 1 and 1′ shown in FIGS. 4 to 13, reference numerals can be suitably modified in accordance with reference numeral 100 of the orthodontic device 100.

The bracket-shaped orthodontic device 1 according to the embodiment will be described in brief.

First, FIG. 14 illustrates the state of the orthodontic treatment of the button-shaped orthodontic device 100 according to the invention.

That is, the button of the orthodontic device 100 of FIG. 14 includes a button body 110 and hook member 150 provided at the button body 110.

The hook member 150 is extended from the button body 110 in the shape of bar. The connection part (connection point P) of traction unit 170 is located in the vicinity of at least gingiva according to the center of resistance (see C.R of FIG. 8).

In addition, the range of the connection point in the center of resistance of the tooth or the extension length S of the hook member is the same as described above.

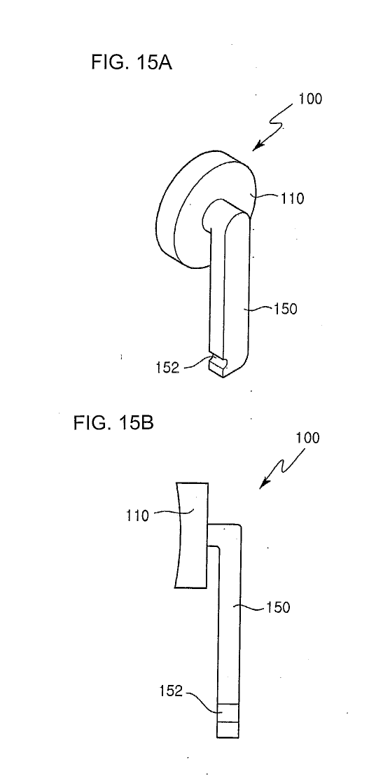

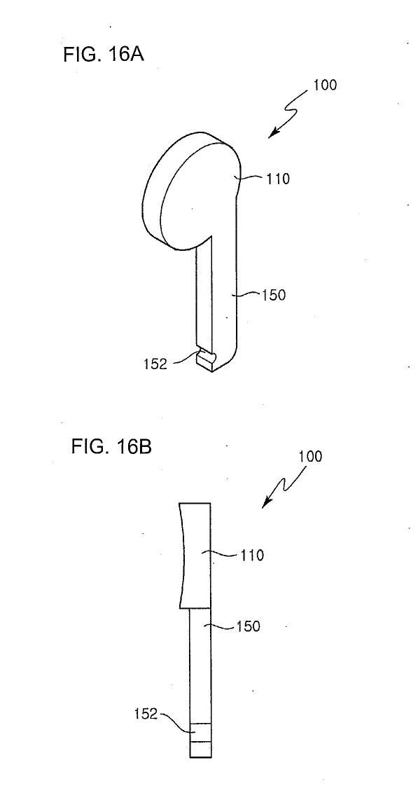

Next, as shown in FIGS. 15 and 16, according to the button-shaped orthodontic device 100, bar-shaped hook member 150 may be provided so as to be integrally extended downwardly from a front surface of the button body 110, or may be provided so as to be integrally extended from the lower end of the button body 110.

Furthermore, a traction unit 170 including a traction wire 172 and a spring 174 in combination with each other is connected to the lower end of the hook member 150, and the lower end of the hook member 150 is provided with a hanger groove 152 that is connected to traction unit 170. The traction unit 170 is connected to anchor member 160 implanted in the jaw bone or alveolar bone.

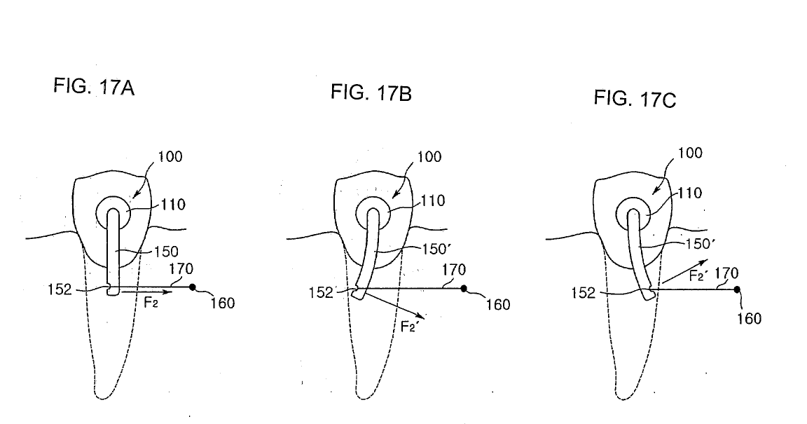

Next, FIGS. 17 to 19 illustrate various modification examples of the hook member 150 provided at the button-shaped orthodontic device 100 of the invention and correspond to FIGS. 10 to 12 described above.

For example, as shown in FIG. 17A, the hook member 150 may be extended in a straight manner from the center of the button body or the lower part of the button body. Furthermore, as shown in FIGS. 17B or 17C, hook member 150 may be extended so as to be curved in a direction opposite to the traction direction pulled out by the traction unit or in the traction direction according to a tooth axis.

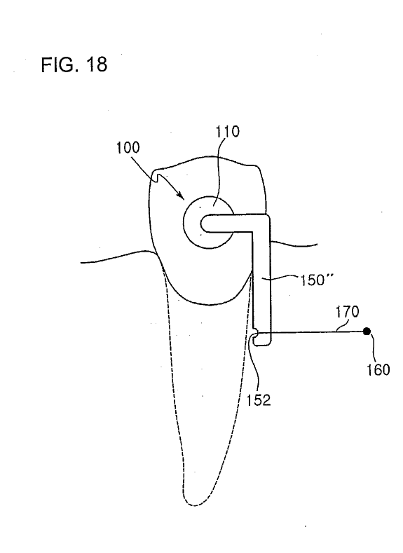

Furthermore, as shown in FIG. 18, the hook member may be provided with folded hook member 150″ that is extended in the shape of reverse-‘L’ shape folded from the center of the button body 110.

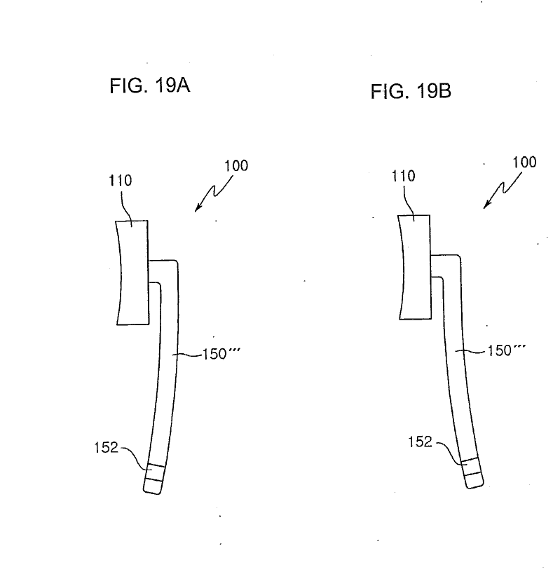

Next, as shown in FIGS. 19A and 19B, the hook member of the invention may be the shape 150′″ that is extended so as to be curved in the lingual direction (for example, the tooth direction) or the buccal direction (opposing direction of the tooth).

According to each orthodontic device 1 and 100 shown in FIGS. 8 and 14, the center line C (generally, slit 12 portion in case of the bracket) thereof corresponds to the center line of the tooth to which the orthodontic device is attached.

Next, FIG. 20 illustrates a combination application of the button-shaped orthodontic device 100 of the invention and the bracket-shaped orthodontic device 200 in the prior art (see FIG. 3) that is engaged with the existing orthodontic wire.

That is, as shown in FIG. 20, an orthodontic wire 220 is inserted into a slit 212, the orthodontic tooth object is attached to the existing bracket-shaped orthodontic device 200 in which the engagement band of a engagement binder 230 is engaged with the tie wings 240, the button-shaped orthodontic device 100 is attached directly below the bracket-shaped orthodontic device 200, and the traction unit 170 is connected to the hanger groove 152 of the hook member 150 that is extended downwardly.

Accordingly, in case of FIG. 20, the orthodontic treatment of total dentitions is performed by the orthodontic wire connected with the brackets, and the orthodontic treatment of a specific tooth may be performed whereby the specific tooth is pulled out by the traction unit.

In case of FIG. 20, though the length of the hook member 150 in the orthodontic device 100 is formed so as to be shorter than that of the hook member in the button-shaped orthodontic device shown in FIGS. 14 to 19, the connection part (that is, the connection point P) of the hook member and the traction unit is located in the vicinity of the center of resistance (C.R) of the tooth or in the vicinity of the gingiva.

FIGS. 21 and 22 illustrate another shapes, for example, the bracket and button-shaped orthodontic devices 1a and 100a including rod-shaped (or steel wire) hook member 50a and 150a instead of the bar-shaped hook member as described above.

In this case, the rod-shaped hook member may be used in the bracket or button made of metal instead of ceramic or resin.

Meanwhile, the lower end of the rod-shaped hook member 50a and 150a may be formed with folded ends 50a′ and 150a′ connected with the traction unit 70 and 170 instead of the above-described hanger groove 52 or 152.

As described above, the bracket or button-shaped orthodontic devices 1, 100, 1a, and 100a according to the invention include the bar or rod-shaped hook member 50, 150, 50a, and 150a that are integrally extended from the bracket body or the tie wings, or from the button front or the lower part of the button body to the vicinity of the center of resistance of the tooth or to the vicinity of the gingiva.

The lower end of the hook member is formed with the hanger groove, the hanger ball, or the curved end. One end of the traction unit 70 and 170 is connected to the anchor member 60 and 160, and the other end thereof is connected to the lower end of the hook member.

Accordingly, the orthodontic device of the invention can pull out the orthodontic tooth object and the dental root without eccentricity, thereby improving the orthodontic properties. In addition, the orthodontic device of the invention can reduce the orthodontic period.

### INDUSTRIAL APPLICABILITY

According to the orthodontic device and the orthodontic method or the present invention, the orthodontic properties are improved, and the orthodontic treatment is easily performed. Furthermore, since the traction line of the anchor member and the traction unit is located in the vicinity of the gingiva, the exterior exposure of the orthodontic device can be reduced.

While the present invention has been shown and described in connection with the preferred embodiments, it will be apparent to those skilled in the art that modifications, and variations can be made without departing from the spirit and scope of the invention as defined by the appended claims.

1-24. (canceled)

25. An orthodontic device, comprising:
teeth-attachment unit attached to an orthodontic tooth object; and
hook member provided in the teeth-attachment unit and having a connection part of a traction unit for straightening irregular teeth that is located in the vicinity of at least gingiva.

26. The orthodontic device according to claim 25, wherein the hook member comprises the connection part of the traction unit that is located in the vicinity of gingiva from a center of resistance (CR) of the tooth.

27. The orthodontic device according to claim 25, wherein the teeth-attachment unit including the hook member is configured with a bracket shape or a button shape.

28. The orthodontic device according to claim 27, wherein the teeth-attachment unit of the bracket shape and the button shape are used in combination thereof, and the hook member is provided in either of the teeth-attachment unit of the bracket shape or the button shape.

29. The orthodontic device according to claim 25, wherein the hook member provided in the teeth-attachment unit is integrally extended from the teeth-attachment unit.

30. The orthodontic device according to claim 29, wherein the hook member is configured by a bar or rod shape that is integrally extended from the teeth-attachment unit, and the traction unit is connected to a lower end of the hook member.

31. The orthodontic device according to claim 29, wherein the teeth-attachment unit is configured with a bracket shape, and the hook member is integrally extended from a bracket body, or tie wings or a cover provided in the bracket body.

32. The orthodontic device according to claim 29, wherein the teeth-attachment unit is configured with a button shape, and the hook member is integrally extended from a lower part of a button body or a front surface of the button body.

33. The orthodontic device according to claim 26, wherein, assuming that a length of dental root is H, the connection part of the traction unit connected with the hook member is located in the range of 0.24 to 0.45×H from an upper end of the dental root to correspond to the center of resistance (CR) of the tooth.

34. The orthodontic device according to claim 25, wherein the hook member is extended by 4 to 14 mm from the teeth-attachment unit to the vicinity of the gingiva.

35. The orthodontic device according to claim 34, wherein the length of the extended hook member is a length from a center of the teeth-attachment unit to the connection part of the hook member connected with the traction unit.

36. The orthodontic device according to claim 31, wherein the bracket body includes a slot into which an orthodontic wire is inserted, the orthodontic wire is fixed as a binder member engaged to the tie wings, or fixed by covering the slot with the cover.

37. The orthodontic device according to claim 30, wherein the hook member includes at least one selected from the group consisting of a hanger groove, a hanger hole, and a folded end serving as the connection part connected with the traction unit so as to facilitate the connection with the traction unit.

38. The orthodontic device according to claim 25, wherein the traction unit is configured such that one end is connected to the hook member and the other end is connected to anchor member implanted in a jaw bone or an alveolar bone, thereby pulling out the tooth.

39. The orthodontic device according to claim 38, wherein the traction unit includes at least one selected from the group consisting of a traction wire, a spring, and an elastic chain, or a combination thereof.

40. The orthodontic device according to claim 29, wherein the hook member is extended upwardly or downwardly from the teeth-attachment unit of the bracket shape or the button shape in a straight or a folded manner to correspond to the position of the orthodontic tooth object.

41. The orthodontic device according to claim 40, wherein the hook member is extended so as to be curved in a traction direction where the hook member is pulled out by the traction unit or an opposite direction thereto according to a tooth axis.

42. The orthodontic device according to claim 40, wherein the hook member is extended so as to be curved or folded in a buccal or lingual direction to adjust a distance between the hook member and the gingiva.

43. An orthodontic method comprising, locating a connection part between a hook member and a traction unit in the vicinity of a center of resistance (CR) of a tooth or in the vicinity of at least gingiva so as to prevent an orthodontic tooth object from being eccentrically pulled out, the hook member being provided in a bracket or a button of an orthodontic device, the traction unit being connected to anchor member to pull out the tooth, and the bracket or the button of the orthodontic device being attached to the tooth, alone or in combination thereof.

44. The orthodontic method according to claim 43, wherein, assuming that a length of dental root is H, the connection part of the traction unit connected with the hook member is located in the range of 0.24 to 0.45×H from an upper end of a dental root to correspond to the center of resistance (CR) of the tooth.

45. The orthodontic method according to claim 43, wherein the hook member is extended by 4 to 14 mm from teeth-attachment unit of the bracket or the button to the vicinity of the gingiva, and the traction unit is connected to a lower end of the hook member.

46. The orthodontic method according to claim 43, wherein the hook member is configured with a bar or rod shape where the hook member is extended integrally from the teeth-attachment unit of the bracket or the button in a straight or a folded manner, and the traction unit is connected to a lower end of the hook member.

47. The orthodontic method according to claim 46, wherein the bar or rod-shaped hook member extended in the straight or folded manner is curved or folded according to a tooth axis or a distance between the hook member and the gingiva.
